(19) United States
(12) Patent Application Publication
(10) Pub. No.: US 2014/0152716 A1
(43) Pub. Date: Jun. 5, 2014

(54) DISPLAY DEVICE AND DRIVING METHOD THEREOF

(71) Applicants: Ji-Gong Lee, Yongin-City (KR); Hideo Yoshimura, Yongin-City (KR); Sang-Jin Pak, Yongin-City (KR); Sang-Kwon Ha, Yongin-City (KR)

(72) Inventors: Ji-Gong Lee, Yongin-City (KR); Hideo Yoshimura, Yongin-City (KR); Sang-Jin Pak, Yongin-City (KR); Sang-Kwon Ha, Yongin-City (KR)

(21) Appl. No.: 13/916,796

(22) Filed: Jun. 13, 2013

(30) Foreign Application Priority Data
Dec. 4, 2012 (KR) 10-2012-0139551

(51) Int. Cl. G09G 3/32

(52) U.S. Cl. CPC G09G 3/3225
USPC 345/691; 345/77

(57) ABSTRACT

A display device and a driving method thereof for reducing power consumption. The display device includes a plurality of pixels positioned at intersection portions of gate lines and data lines; a gate driver selectively driving the gate lines; a data driver supplying, to the data lines, data corresponding to the gate line selected from the gate lines; and a timing controller controlling the gate drive and the data driver. In the display device, the timing controller includes an order determination unit that compares data for each gate line and determines a driving order of the gate lines.

### CLAIM OF PRIORITY

This application makes reference to, incorporates the same herein, and claims all benefits accruing under 35 U.S.C. §119 from an application for DISPLAY DEVICE AND DRIVING METHOD THEREOF earlier filed in the Korean Intellectual Property Office on 4 Dec. 2012 and there duly assigned Serial No. 10-2012-0139551.

### BACKGROUND OF THE INVENTION

1. Field of the Invention

An aspect of the present invention relates to a display device and a driving method thereof, and more particularly, to a display device and a driving method thereof, which can reduce power consumption.

2. Description of the Related Art

In general, a display device is driven using an analog or digital method. In the analog driving method, gray scales are implemented using voltage differences. In the digital driving method, gray scales are implemented using time differences.

In the analog driving method, gray scales are implemented by respectively applying different data voltages to pixels. That is, in the analog driving method, a data voltage corresponding to each gray scale, and the luminance of the pixels is controlled corresponding to the generated data voltage. In the analog driving method, data voltages having a plurality of levels should be generated to corresponding to the number of the gray scales. An organic light emitting display device or the like is used as an example of the display device to which the analog driving method can be applied. However, in the organic light emitting display device using the analog driving method, a luminance variation occurs due to a variation in characteristics of the pixels even when the same data voltage is supplied to the pixels. Therefore, it is difficult to express a precise gray scale.

On the other hand, in the digital driving method, gray scales are implemented by controlling emission and non-emission, i.e., a display period of each pixel. The digital driving method can solve the difficulty in expressing the precise gray scale, caused in the organic light emitting display device using the analog driving method. Accordingly, the digital driving method in which gray scales are expressed by adjusting the emission time of each pixel is applied to the organic light emitting display device, etc. As such, the digital driving method has recently been widely applied.

In a case where a display device is driven using the digital driving method, one frame is divided into a plurality of subframes having different weight values, and a data meaning “emission” or “non-emission,” e.g., data “1” or “0” is supplied to data lines for each subframe, thereby expressing gray scales.

However, if the display device is driven using the digital driving method, gray scales are expressed while repetitively charging/discharging data lines and capacitors in pixels at a fast frequency, and therefore, power consumption is increased. Particularly, as a display panel has a large size and high resolution, the number of lines to be driven increases, and the driving frequency increases. Therefore, the increase in power consumption is deepened. Accordingly, it is required to propose a plan for reducing power consumption while implementing a display device using the digital method.

### SUMMARY OF THE INVENTION

Embodiments provide a display device and a driving method thereof, which can reduce power consumption.

According to an aspect of the present invention, there is provided a display device, including: a plurality of pixels positioned at intersection portions of gate lines and data lines; a gate driver selectively driving the gate lines; a data driver supplying, to the data lines, data corresponding to the gate line selected from the gate lines; and a timing controller controlling the gate drive and the data driver, wherein the timing controller includes an order determination unit that compares data for each gate line and determines a driving order of the gate lines.

The order determination unit may perform a test for the degree of similarity between data for each gate line, and determine the driving order of the gate lines so that data having high degrees of similarity are consecutively supplied to the data lines.

The data may be supplied in the form of digital binary code data, and the order determination unit may determine the driving order of the gate lines by comparing data assigned to the same data line for each gate line and counting the number of data agreed with each other.

The order determination unit may include an exclusive or operator that counts the number of the data agreed with each other.

The order determination unit may perform the test for the degree of similarity with respect to data corresponding to the other gate lines, based on a data corresponding to a predetermined first gate line, and select, as a second gate line, a gate line to which a data most similar to that corresponding to the first gate line is assigned.

The order determination unit may determine the driving order of all the gate lines by repeating a process of selecting a third gate line by performing the test for the degree of similarity with respect to data corresponding to the other gate lines, based on a data corresponding to the second gate line, after the second gate line is selected, and performing the test for the degree of similarity with respect to data corresponding to the other gate lines, based on a data corresponding to the third gate line.

The order determination unit may provide a flag bit to the data corresponding to the gate lines of which driving order is determined, so that when the test for the degree of similarity is subsequently performed, based on a data corresponding to another gate line, the test of the degree of similarity with respect to the gate lines having the flag bit provided thereto is excluded.

The first gate line may be set as a gate line disposed on the first horizontal line.

The order determination unit may perform the test for the degree of similarity with respect to data corresponding to the other gate lines, based on a predetermined first gate line. If a gate line having the degree of similarity greater than a predetermined reference value is searched, the order determination unit may select the searched gate line as a second gate line.

If the second gate line is selected, the order determination unit may stop the test for the degree of similarity, based on the first gate line, and simultaneously perform the test for the degree of similarity with respect to data corresponding to the other gate lines, based on a data corresponding to the second gate line.

If a gate line on which the data having the degree of similarity is no less than the reference value is searched while the test for the degree of similarity is being performed, based on the data corresponding to the second gate line, the order determination unit may stop the test for the degree of similarity with respect to the second gate line, and select the searched gate line as a third gate line, thereby determining the driving order of all the gate line.

The order determination unit may provide a flag bit to the data corresponding to the gate lines of which driving order is determined, so that when the test for the degree of similarity is subsequently performed, based on a data corresponding to another gate line, the test of the degree of similarity with respect to the gate lines having the flag bit provided thereto is excluded.

The gate lines may be divided into a plurality of groups, and the order determination unit may perform a test for the degree of similarity, which compares data corresponding to gate lines in a corresponding group for each group.

If the determination of the driving order of gate lines in one group is completed, the order determination unit may determine a driving order of gate lines in a next group.

The order determination unit may start the determination of the driving order of the gate lines in the next group, based on a data corresponding to the gate line finally selected in the group in which the determination of the driving order of the gate lines has been completed.

The supply of the data corresponding to the gate line in the group in which the determination of the driving order of the gate lines has been completed may be performed while the driving order of the gate lines on the next group is being determined.

The order determination unit may determine the driving order of the gate lines so that the gate lines in each group are sequentially driven.

The order determination unit may generate a gate driving control signal corresponding to the determined driving order of the gate lines, and supply the gate driving control signal to the gate driver.

The gate driver may be implemented as a decoder that selects a gate line by outputting a selection signal corresponding to the gate driving control signal.

The display device may be driven using a digital method in which one frame is divided into a plurality of subframes, and the gate lines are driven in a driving order determined by the order determination unit for each subframe.

The order determination unit may generate a gate driving control signal corresponding to the determined driving order of the gate lines, and simultaneously rearrange the data, corresponding to the driving order.

The display device may further include a storage unit storing the date rearranged by the order determination unit.

According to an aspect of the present invention, there is provided a driving method of a display device, including: selecting one gate line to be a reference gate line from a plurality of gate lines and setting the selected gate line as a first gate line; comparing a data assigned to the first gate line with data corresponding to the other gate lines; selecting a gate line to be driven next to the first gate line, corresponding to the compared result, and setting the selected gate line as a second gate line; comparing a data assigned to the second gate line with data corresponding to the other gate lines, based on the second gate line; and selecting a gate line to be driven next to the second gate line, corresponding to the compared result, and setting the selected gate line as a third gate line, wherein the driving order of all the gate lines is determined while repeating a process of setting a gate line to be driven next to a reference gate line by changing one gate line into a gate line to be the reference gate line whenever the driving order of the one gate line is determined, and comparing a data corresponding to the reference with data corresponding to the other gate lines, and data are supplied to data lines while driving the gate lines, corresponding to the driving order.

The comparing of the data for each gate line may include performing a test for the degree of similarity between the data, and determining the driving order of the gate lines so that data having high degrees of similarity are consecutively supplied to the data lines.

A gate line disposed on the first horizontal line may be set as the first gate line.

The comparing of the data assigned to the reference gate line with the data corresponding to the other gate lines may include detecting a comparison result by comparing the data corresponding to the reference gate line with data corresponding to all gate lines of which driving order is not determined yet.

The comparing of the data assigned to the reference gate line with the data corresponding to the other gate lines may include performing a test for the degree of similarity between two data, and selecting a gate line to which a data the highest degree of similarity is assigned among the other gate lines as a gate line to be driven next to the reference gate line.

A flag bit may be provided to the data corresponding to the gate lines of which driving order is determined, so that when the test for the degree of similarity is subsequently performed, based on a data corresponding to another gate line, the test of the degree of similarity with respect to the gate lines having the flag bit provided thereto is excluded.

The comparing of the data assigned to the first gate line with the data corresponding to the other gate lines may include performing a test for the degree of similarity between two data. If a data having the degree of similarity greater than a predetermined reference value is searched, the test for the degree of similarity may be stopped, based on the first gate line, and a gate line to which the searched data may be assigned is set as the second gate line.

The gate lines may be divided into a plurality of groups, and the driving order of gate lines in a corresponding group may be determined for each group.

The driving order of the gate lines may be determined so that the gate lines in each group are sequentially driven.

If the determination of the driving order of gate lines in one group is completed, the driving order of gate lines in a next group may be determined by setting the gate line finally driven in the one group as the first gate line.

Data corresponding to the gate lines in the group in which the determination of the driving order of the gate line has been completed may be supplied while the driving order of the gate lines in the next group is determined.

As described above, according to the present invention, the display device has an order determination unit that determines a driving order of gate lines by comparing data for each gate line. Particularly, when comparing data for each gate line, the order determination unit performs a test for the degree of similarity between the data, and determines the driving order of the gate lines so that data having high degrees of similarity can be consecutively supplied to data lines. Accordingly, it is possible to reduce power consumption of the display device.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a circuit diagram illustrating an example of a pixel in an organic light emitting display device;

FIG. 2 is a view illustrating one frame in a display device driven using a digital driving method;

FIG. 3 is a block diagram illustrating a display device according to an embodiment of the present invention, which illustrates an example in which the present invention is applied to an organic light emitting display device;

FIGS. 4(a) and 4(b) are views comparing a comparative example in which gate lines are sequentially driven with an example in which a driving order of the gate lines is determined according to the embodiment of the present invention;

FIG. 5 is a flowchart illustrating a method of determining a driving order of the gate lines according to an embodiment of the present invention; and

FIG. 6 is a flowchart illustrating a method of determining a driving order of the gate lines according to another embodiment of the present invention.

### DETAILED DESCRIPTION OF THE INVENTION

Hereinafter, certain exemplary embodiments according to the present invention will be described with reference to the accompanying drawings. Here, when a first element is described as being coupled to a second element, the first element may be not only directly coupled to the second element but may also be indirectly coupled to the second element via a third element. Further, some of the elements that are not essential to the complete understanding of the invention are omitted for clarity. Also, like reference numerals refer to like elements throughout.

Hereinafter, for convenience of illustration, the exemplary embodiments of the present invention will be applied to an organic light emitting display device, but the present invention is not limited thereto. That is, the technical scope of the present invention can be applied to other display devices such as a plasma display panel (PDP).

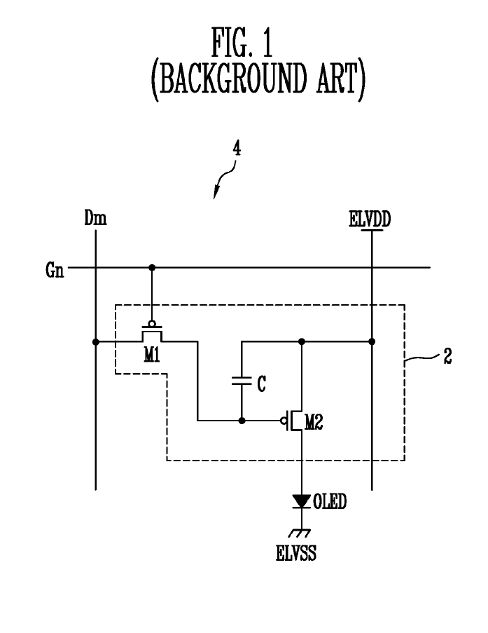

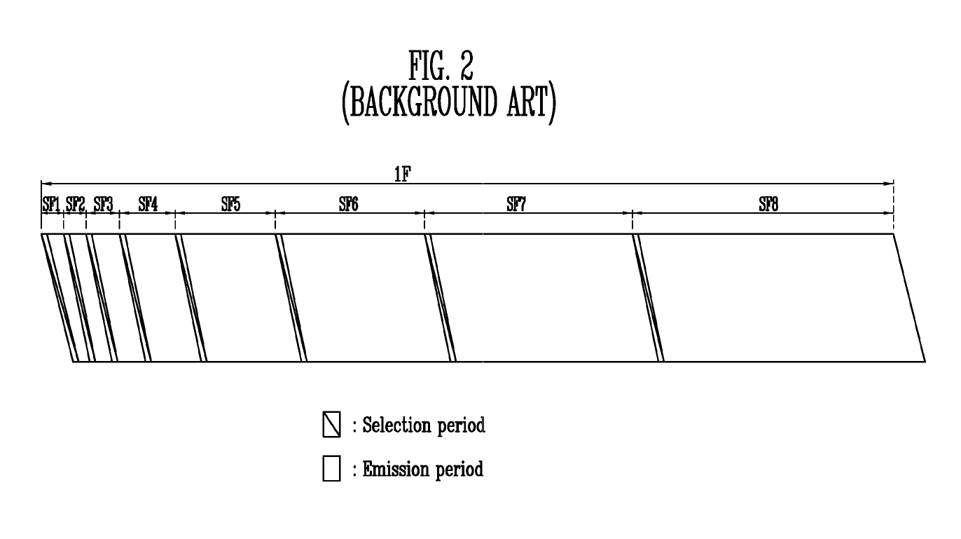

FIG. 1 is a circuit diagram illustrating an example of a pixel in an organic light emitting display device. FIG. 2 is a view illustrating one frame in a display device driven using a digital driving method.

First, referring to FIG. 1, the pixel 4 includes an organic light emitting diode OLED, and a pixel circuit 2 coupled to a gate line Gn and a data line Dm so as to control the organic light emitting diode OLED.

An anode electrode of the organic light emitting diode OLED is coupled to the pixel circuit 2, and a cathode electrode of the organic light emitting diode OLED is coupled to a second voltage ELVSS. The organic light emitting diode OLED emits light, corresponding to current supplied from the pixel circuit 2.

The pixel circuit 2 controls current supplied to the organic light emitting diode OLED, corresponding to data supplied to the data line Dm when a selection signal is supplied to the gate line Gn. To this end, the pixel circuit 2 includes a second transistor M2 coupled between a first voltage ELVDD and the organic light emitting diode OLED, a first transistor M1 coupled among the second transistor M2, the data line Dm and the gate line Gn, and a storage capacitor C coupled between a gate electrode and a first electrode of the second transistor M2.

A gate electrode of the first transistor M1 is coupled to the gate line Gn, and a first electrode of the first transistor M1 is coupled to the data line Dm. A second electrode of the first transistor M1 is coupled to one terminal of the storage capacitor C. Here, the first electrode is set as any one of source and drain electrodes, and the second electrode is set as an electrode different from the first electrode. For example, if the first electrode is set as the source electrode, the second electrode is set as the drain electrode. When the selection signal is supplied from the gate line Gn, the first transistor M1 coupled to the gate line Gn and the data line Dm is turned on to supply data supplied from the data line to the storage capacitor C. In this case, the storage capacitor C charges a voltage corresponding to the data.

The gate electrode of the second transistor M2 is coupled to the one terminal of the storage capacitor C, and the first electrode of the second transistor M2 is coupled to the other terminal of the storage capacitor C and the first voltage ELVDD. A second electrode of the second transistor M2 is coupled to the anode electrode of the organic light emitting diode OLED. The second transistor M2 controls current supplied from the first voltage ELVDD to the second voltage ELVSS via the organic light emitting diode OLED, corresponding to the voltage stored in the storage capacitor C, so as to control the luminance of the organic light emitting diode OLED or to operate as a switch for controlling the organic light emitting diode OLED to emit light or not to emit light during a predetermined emission period.

The pixel 4 of the organic light emitting display device displays an image by repeating the process described above.

In the organic light emitting display device using an analog driving method, a data voltage corresponding to the gray scale of a corresponding data is supplied to the pixel 4 through the data line Dm of the pixel 4, and current corresponding to the data voltage is flowed in the organic light emitting diode OLED by the second transistor M2, thereby displaying the gray scale of the pixel 4. However, in the pixel 4 using the analog driving method, it may be difficult to express a precise gray scale due to various factors such as a variation in threshold voltage of the second transistor M2.

Meanwhile, in the organic light emitting display device using a digital driving method, in which the second transistor M2 operates as a switch, one frame 1F is divided into a plurality of subframes SF. Each subframe SF is configured to include a selection period and an emission period. If the first transistor M1 is turned on by selecting gate lines (e.g., G1-Gn) in a predetermined driving order during the selection period, pixels connected to the selected gate lines receive a first or second data while being connected to the data line (e.g., D1-Dm). Here, the first and second data are different data. For example, if the first data is set as a data for allowing the pixel to emit light, e.g., data “1,” the second data is set as a data for allowing the pixel not to emit light, e.g., data “0.” Here, the data “1” and “0” may be supplied in the forms of low and high voltages opposite to each other.

That is, according to the digital driving method, each pixel is selected to emit light or not to emit light for each subframe (SF1-SF8), and weight values are provided by differently setting the emission period of each subframe (SF1-SF8), so that it is possible to express a desired gray scale by controlling the emission time of the pixel. If the organic light emitting display device is driven using the digital driving method, it is possible to increase the accuracy of gray scale expression.

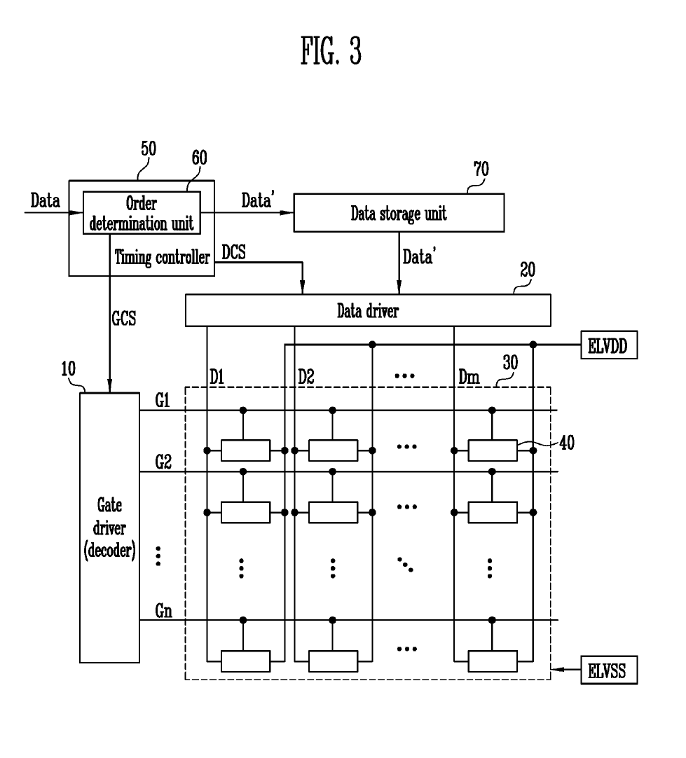

However, if a display device is driven using the digital driving method, one frame 1F is divided into a plurality of subframes (SF1-SF8), and a corresponding data should be supplied by sequentially selecting gate lines (G1-Gn) during each subframe (SF1-SF8). That is, in a case where the digital driving method is used, gray scales are expressed by repetitively charging/discharging data lines (D1-Dm) and capacitors in pixels at a fast frequency, and accordingly, power consumption increases. Particularly, as a display panel has a large size and high resolution, the number of lines to be driven increases, and the driving frequency increases. Therefore, the increase in power consumption is deepened. Accordingly, the present invention discloses a plan for reducing power consumption while implementing a display device using the digital method. This will be described in detail with reference to FIGS. 3 to 6.

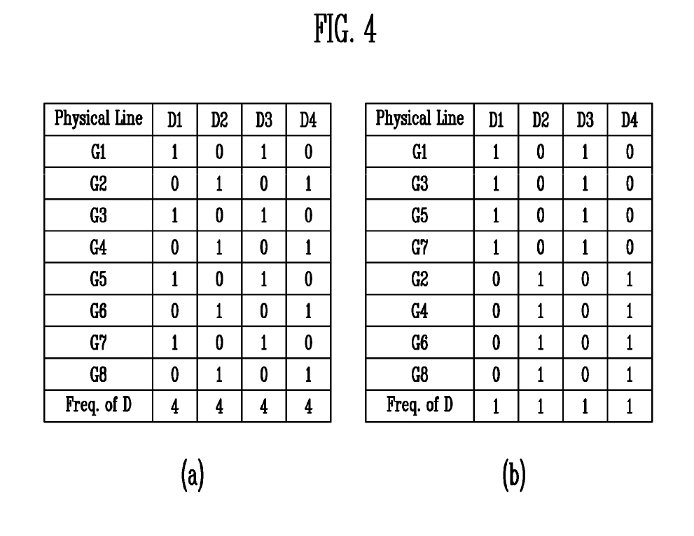

FIG. 3 is a block diagram illustrating a display device according to an embodiment of the present invention, which illustrates an example in which the present invention is applied to an organic light emitting display device. FIGS. 4(a) and 4(b) are views comparing a comparative example in which gate lines are sequentially driven with an example in which a driving order of the gate lines is determined according to the embodiment of the present invention.

First, referring to FIG. 3, the organic light emitting display device according to this embodiment includes a pixel unit 30 having a plurality of pixels 40 positioned at intersection portions of gate lines G1 to Gn and data lines D1 to Dm, a gate driver 10 (scan driver) selectively driving the gate lines G1 to Gn, a data driver 20 supplying data corresponding to data lines D1 to Dm, and a timing controller 50 controlling the gate driver 10 and the data driver 20.

Particularly, the timing controller 50 includes an order determination unit 60 determining a driving order of the gate lines G1 to Gn by comparing data for each gate line. The organic light emitting display device according to this embodiment may further include a data storage unit 70 storing data Data' rearranged by the order determination unit 60.

The gate driver 10 selectively drives the gate lines G1 to Gn while supplying a selection signal to the gate lines G1 to Gn. The gate driver 10 outputs a selection signal corresponding to a gate driving control signal GCS supplied from the order determination unit 60 of the timing controller 50, and accordingly selects a gate line G.

The gate driver 10 of the present invention is not designed as a shift register sequentially selecting the gate lines G1 to Gn according to a substantially predetermined arrangement order, but designed to freely change the driving order of the gate lines G1 to Gn, corresponding to the gate driving control signal GCS. For example, the gate driver 10 may be implemented as a decoder that uses the gate driving control signal GCS as an input signal and uses the selection signal as an output signal.

Meanwhile, the present invention can be applied to the display device using the digital driving method as described with reference to FIG. 2. One frame 1F may be divided into a plurality of subframes SF having different weight values. In this case, the gate driver 10 selectively drives the gate lines by outputting a selection signal corresponding to the gate driving control signal GCS in every selection period of each subframe SF. That is, the organic light emitting display device of the present invention is driven using the digital driving method, and the gate lines G1 to Gn are driven in a driving order determined by the order determination unit 60 for each subframe SF. If the selection signal is supplied to the gate lines G1 to Gn, pixels 40 are selected for each horizontal line, and the selected pixels 40 receive data supplied from the data lines D1 to Dm.

The data driver 20 supplies data to the data lines D1 to Dm whenever the selection signal is supplied to the gate lines G1 to Gn during the selection period of each subframe SF. Here, the organic light emitting display device of the present invention is driven using the digital driving method, and thus data driver 20 supplies data, i.e., a first data for allowing the pixels 40 to emit light and a second data for allowing the pixels 40 not to emit light. Then, the pixels 40 receiving the first data during an emission period included in a subframe SF emit light during the emission period assigned to the corresponding subframe.

The pixel unit 30 receives a first voltage ELVDD, a second voltage ELVSS, a selection signal and data, supplied from the outside thereof, and displays an image corresponding to the data. Here, each pixel 40 receives the first or second data supplied from the corresponding data line D1 to Dm when the selection signal is supplied to the gate line connected to the pixel 40 during each subframe, and emits light or does not emit light, corresponding to the received first or second data.

The timing controller 50 generates the gate driving control signal GCS and a data driving control signal DCS, corresponding to synchronization signals (not shown) supplied from the outside thereof. The gate driving control signal GCS generated by the order determination unit 60 in the timing controller 50 is supplied to the gate driver 10, and the data driving control signal DCS generated in the timing controller 50 is supplied to the data driver 20.

The order determination unit 60 generates the gate driving control signal GCS corresponding to the driving order determined by a predetermined reference, and supplies the gate driving control signal GCS to the gate driver 10.

The timing controller 50 also performs a function of receiving data Data supplied from the outside thereof and providing the received data Data to the data driver 20. Here, the timing controller 50 of the present invention may compare the data Data for each gate line by driving the order determination unit 60, and determine a driving order of the gate lines G1 to Gn so that power consumption can be reduced, corresponding to the compared result. In addition, the timing controller 50 may rearrange the data Data, corresponding to the determined driving order of the gate lines G1 to Gn, and then supply the rearranged data Data' to the data storage unit 70.

More specifically, the order determination unit 60 receives data Data supplied from the outside and compares the data Data for each gate line (e.g., each horizontal line), thereby determining a driving order of the gate lines G1 to Gn. Here, the order determination unit 60 determines the driving order of the gate lines G1 to Gn so that power consumption can be reduced by decreasing the number of times of charging/discharging each of the data lines D1 to Dm.

To this end, the order determination unit 60 performs a test for the degree of similarity between data Data for each gate line G, and determines the driving order of the gate lines G1 to Gn so that data Data having high degrees of similarity can be consecutively supplied to the data lines D1 to Dm.

Particularly, since data Data are supplied in the form of digital binary code data in the digital driving method, the order determination unit 60 can decide the degree of similarity between data Data by determining the agreement or disagreement of the digital binary code data.

The order determination unit 60 may compare data Data corresponding to one gate line with data Data corresponding to the other gate lines, based on the one gate line. For example, the order determination unit 60 may determine a driving order of the gate lines G1 to Gn by comparing data Data assigned to the same data line D for each gate line and counting the number of data agreed with each other.

To this end, the order determination unit 60 has an exclusive or (XOR) operator, and counts the number of data Data agreed between data Data corresponding to two gate lines (data Data corresponding to the reference gate line and data Data corresponding to another gate line to be compared) by operating the exclusive or operator. Subsequently, the order determination unit 60 determines a driving order of the gate lines G1 to Gn, based on the compared result, so that data having high degrees of similarity can be consecutively supplied to the data lines D1 to Dm.

For example, when a data Data corresponding to each gate line G is assigned as shown in FIGS. 4(a) and 4(b), the data Data is supplied to data lines D1 to D4 while sequentially selecting gate lines G1 to G8 according to a physical arrangement order as shown in FIG. 4(a). Then, power consumption is increased while charging/discharging the data lines D1 to D4 in every horizontal period of each subframe SF.

However, if the order determination unit 60 of this embodiment consecutively drives the gate lines G1 to G8 to which data having high degrees of similarity are assigned by comparing data Data corresponding to the gate lines G1 to G8 for each data input to the same data line D, the driving frequency of the data lines D1 to D4 can be decreased while remarkably decreasing the number of times of charging/discharging the data lines D1 to D4 as shown in FIG. 4(b), thereby reducing power consumption. In a case where there exist a plurality of gate lines having the same degree of similarity as the reference gate line, the driving order of the plurality of gate lines is determined, based on the physical arrangement order. As such, the rule for driving orders can be previously determined.

Meanwhile, for convenience of illustration, the data Data assigned to only the gate lines G1 to G8 and the data lines D1 to D4 have been illustrated as an example in FIGS. 4(a) and 4(b). However, in an actual display device, a large number of gate lines G and data lines D are driven at a high frequency. Accordingly, if the driving order of the gate lines G is changed by applying the technical spirit of the present invention, it can be predicted that the reduction in driving frequency (Freq. of D) and power consumption will be increased.

As described above, the display device of the present invention has the order determination unit 60 that compares data Data for each gate line and determines a driving order of the gate lines G, corresponding to the compared result. Particularly, the order determination unit 60 performs a test for the degree of similarity between data in the comparison of the data for each gate line, and determines the driving order of the gate lines G so that data having high degrees of similarity can be consecutively supplied to the data lines D. Accordingly, the power consumption can be reduced as the number of times of charging/discharging the data lines D is decreased, and the driving frequency (Freq. of D) is lowered. Particularly, when the degree of similarity of the consecutively supplied data is small, e.g., when data opposite to each other are consecutively supplied, the reduction in power consumption increases. Thus, the maximum output specification of a power component can be decreased by lowering peak power, and it is possible to reduce the occurrence of electromagnetic waves that may have influence on other electronic devices.

The method of determining a driving order of the gate lines G using the order determination unit 60 will be described in detail. The method includes selecting one gate line to be a reference gate line from a plurality of gate lines G and setting the selected gate line as a first gate line to be first driven; a data assigned to the first gate line with data corresponding to the other gate lines; selecting a gate line to be driven next to the first gate line, corresponding to the compared result, and setting the selected gate line as a second gate line; comparing a data assigned to the second gate line with data corresponding to the other gate lines, based on the second gate line; and selecting a gate line to be driven next to the second gate line, corresponding to the compared result, and setting the selected gate line as a third gate line. By repeating the process described above, the driving order of all the gate lines G can be determined.

That is, whenever the driving order of one gate line is determined, the order determination unit 60 changes the gate line of which driving order is determined into a reference gate line and compares a data of the reference gate line with data corresponding to the other gate lines of which driving order is not determined yet. Then, the order determination unit 60 sets a gate line to be driven next to the reference gate line, corresponding to the compared result. By repeating the process described above, the order determination unit 60 can determine the driving order of all the gate lines G. Here, the gate line that initially becomes the reference gate line may be arbitrarily set. For example, the process of determining the driving order of the gate lines G can be started by setting a gate line disposed on the first horizontal line as a first gate line.

Particularly, when comparing data for each gate line, the order determination unit 60 performs a test for the degree of similarity, and determines the driving order of the gate lines G so that data having high degrees of similarity can be consecutively supplied to the data lines D. If gate lines G are driven according to the driving order determined by the order determination unit 60, the data assigned to pixels coupled to the corresponding gate lines G are supplied to the data lines D.

Here, the method of comparing data for each gate line and determining the driving order of the gate lines, based on the compared result, may be divided into two methods.

One of the two methods is a method of determining the driving order of all the gate lines G. In this method, if one gate line is set as a reference gate line, the order determination unit 60 compares a data corresponding to the reference gate line with all data corresponding to the other gate lines of which driving order is not determined yet, and sets a gate line to which a data having the highest degree of similarity is assigned as a gate line to be driven next to the reference gate line.

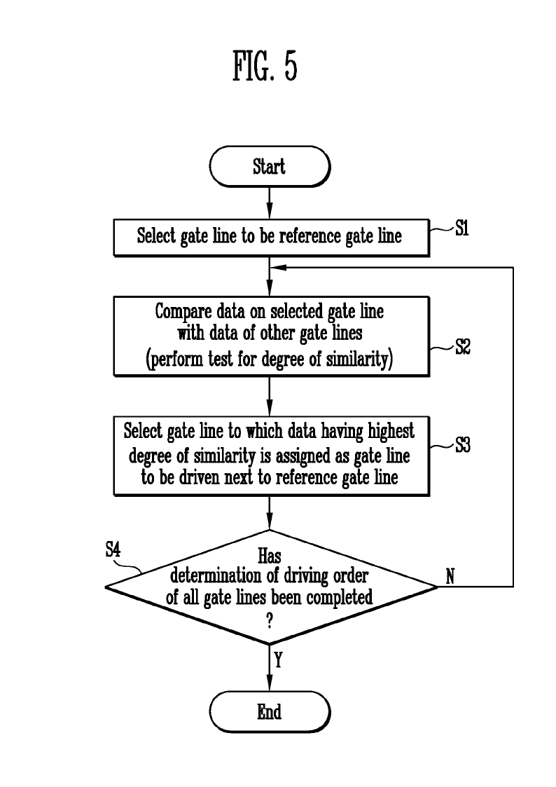

In this case, the order determination unit 60 provides the data corresponding to the gate lines of which driving order is determined with a flag bit for allowing the gate lines not to be searched again. Accordingly, when the test for the degree of similarity is subsequently performed on data corresponding to other gate lines, the test for the gate lines having the flag bit provided thereto can be excluded. The method will be described in detail later with reference to FIG. 5.

If a data corresponding to one reference gate line is compared with data corresponding to the other gate lines of which driving order is not determined, a gate line to which a data most similar to the data assigned to the reference gate line is assigned is set as a gate line to be driven next to the reference gate line. Thus, the driving order of the gate lines G can be optimally determined in terms of the degree of similarity of data consecutively supplied through the data line D. Accordingly, it is possible to minimize power consumption for driving the data lines D.

Meanwhile, in the other of the two methods, the order determination unit 60 previously sets a predetermined reference value for the degree of similarity, and performs a test for the degree of similarity between data in a process of comparing a data corresponding to one reference gate line with data corresponding to the other gate lines of which driving order is not determined yet. If a data having a degree of similarity greater than the reference value is searched, the order determination unit 60 stops the test for the degree of similarity with respect to the current reference gate line and the other gate lines, and a gate line to which the searched data is assigned is set as a gate line to be driven next to the reference gate line. In this case, the order determination unit 60 determines the driving order of the other gate lines by repeating the method of performing the test for the degree of similarity using the gate line of which driving order is determined as a reference gate line.

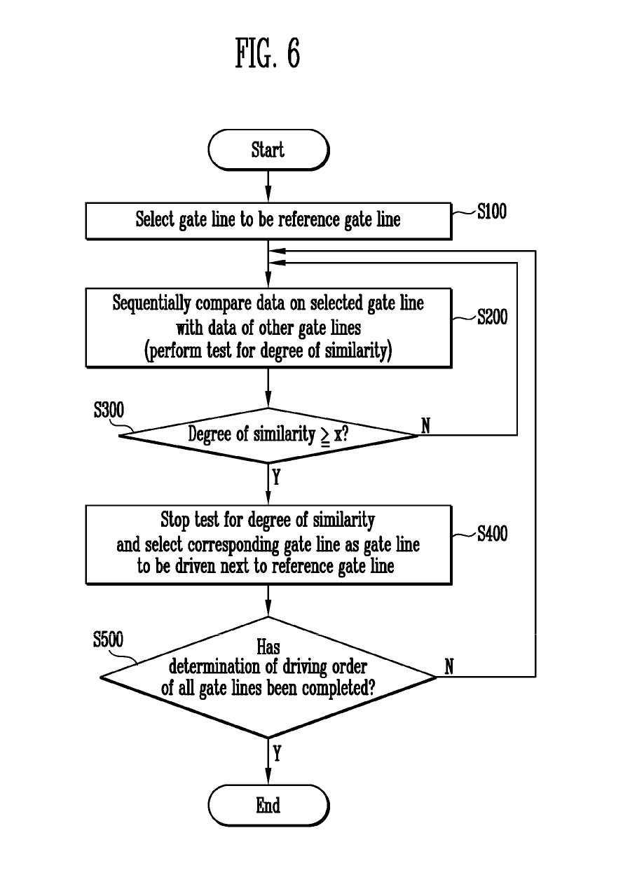

If the driving order of the gate lines G is determined using the method described above, the time required to determine the driving order of the gate lines can be decreased while obtaining reduction in power consumption to some degree, thereby improving the driving speed of the display device. The method will be described in detail later with reference to FIG. 6.

FIG. 5 is a flowchart illustrating a method of determining a driving order of the gate lines according to an embodiment of the present invention.

Referring to FIG. 5, the method according to this embodiment includes selecting (S1) a gate line to be a reference gate line, comparing (S2) a data corresponding to the selected gate line with data corresponding to the other gate lines, selecting (S3) a gate line to which a data having the highest degree of similarity is assigned as a gate line to be driven next to the reference gate line, and deciding (S4) whether the determination of the driving order of all the gate lines has been completed.

More specifically, the order determination unit first selects a gate line to be initially a reference gate line. For example, the order determination unit may select a gate line disposed on the first horizontal line and set the selected gate line as a first gate line.

Subsequently, the order determination unit compares a data corresponding to the first gate line with data corresponding to the other gate lines. The comparison can be achieved by performing a test for the degree of similarity between data. In this case, the order determination unit compares the data assigned to the first gate line with the data corresponding to the other gate lines. Particularly, the order determination unit selects a gate line to which a data having the highest degree of similarity is assigned among the other gate lines as a second gate line to be driven next to the first gate line by performing the test for the degree of similarity between the compared data.

If the second gate line is selected, the order determination unit compares a data corresponding to the second gate line with data of the other gate lines, based on the data corresponding to the second gate line, i.e., the other gate lines of which driving order is not determined yet, and selects, as a third gate line, a gate line to which a data most similar to the data corresponding to the second gate line among the other gate lines is assigned.

Subsequently, the order determination unit determines the driving order of all the gate lines by repeating the process of performing the test for the degree of similarity between data corresponding to the other gate lines, based on a data corresponding to the third gate line. That is, the driving order of all the gate lines can be determined by repeating the process of changing the third gate line into a reference gate line and performing the test for the degree of similarity between the data corresponding to the other gate lines.

Here, a flag bit is provided to the gate lines of which driving order is determined, so that when the test for the degree of similarity is subsequently performed, based on a data corresponding to another gate line, the test for the gate lines having the flag bit provided thereto can be excluded.

As described above, if a comparison result is detected by comparing the data assigned to the reference gate line with the data corresponding to the other gate lines of which driving order is not determined yet, the driving order of the gate lines G can be optimally determined in terms of the degree of similarity of data consecutively supplied through the data line D. Accordingly, it is possible to minimize power consumption for driving the data lines D.

FIG. 6 is a flowchart illustrating a method of determining a driving order of the gate lines according to another embodiment of the present invention.

Referring to FIG. 6, the method according to this embodiment includes selecting (S100) a gate line to be a reference gate line, performing (S200) a test for the degree of similarity, which sequentially compares a data corresponding to the selected gate line with data corresponding to the other gate lines, deciding (S300) whether a data corresponding to a gate line, compared with the data of the reference gate line satisfies a predetermined reference value x, selecting (S400) the corresponding gate line as a gate line to be driven next to the reference gate line, when the degree of similarity is no less than the reference value x, and deciding (S500) whether the determination of the driving order of all the gate lines has been completed. By repeating the process described above, the driving order of all the gate lines can be determined. In the deciding whether the data corresponding to the gate line, compared with the data corresponding to the reference gate line, satisfies the predetermined reference value x (S300), if the degree of similarity does not satisfy the reference value x, the process of comparing the data corresponding to a next gate line (e.g., a gate line next to the gate line which does not satisfy the reference value x according to the physical arrangement order) among the other gate lines with the data corresponding to the reference gate line is repetitively performed.

More specifically, the order determination unit first selects a gate line to be initially a reference gate line. For example, the order determination unit may select a gate line disposed on the first horizontal line and set the selected gate line as a first gate line.

Subsequently, the order determination unit sequentially compares a data corresponding to the first gate line with data corresponding to the other gate lines. The comparison can be achieved by performing a test of the degree of similarity between the data. If a data having the degree of similarity greater than a predetermined reference value x is searched, the order determination stops the test for the degree of similarity, based on the first gate line, and sets a gate line to which the searched data is assigned as a second gate line.

If the second gate line is selected, the order determination unit sequentially compares a data corresponding to the second gate line with data corresponding to the other gate lines of which driving order is not determined yet, based on the data corresponding to the second gate line. If the data having the degree of similarity greater than the predetermined reference value x is searched, the order determination unit stops the test for the degree of similarity, based on the second gate line, and sets a gate line to which the searched data is assigned as a third gate line.

Subsequently, the order determination unit determines the driving order of all the gate lines by repeating the process of performing the test for the degree of similarity between a data corresponding to the third gate line and data corresponding to the other gate lines, based on the data of the third gate line. That is, the driving order of all the gate lines can be determined by repeating the process of changing the third gate line into a reference gate line and performing the test for the degree of similarity between a data corresponding to the reference gate line and data of the other gate lines, based on the data corresponding to the reference gate line.

Here, a flag bit is provided to the gate lines of which driving order is determined, so that when the test for the degree of similarity is subsequently performed, based on a data corresponding to another gate line, the test for the gate lines having the flag bit provided thereto can be excluded.

As described above, in this embodiment, if a data satisfying the predetermined reference value x is searched in the process of searching a gate line to which a data similar to that on a predetermined reference gate line, the test for the degree of similarity with respect to the data corresponding to the current reference gate line is stopped, and the gate line to which the searched data is assigned is selected as a gate line to be driven next to the reference gate line. The driving order of the gate lines is determined as described above, so that it is possible to improve the driving speed of the display device while obtaining reduction in power consumption to some degree.

Meanwhile, by applying the technical spirit of the present invention described with reference to FIGS. 3 to 6, the gate lines may be divided into a plurality of groups, and the driving order of gate lines in a corresponding group may be determined. For example, when the technical spirit of the present invention is applied to a high-resolution, large-sized display device in which a large number of gate lines and data lines are arranged, a region may be defined, based on the gate lines, and the driving order of gate lines in the defined region may be determined. That is, the order determination unit may perform a test for the degree of similarity, which compares data corresponding to gate lines in a corresponding group.

For example, the driving order of gate lines may be sequentially determined for each group, using a method of dividing the gate lines into a plurality of groups for each region, and determining the driving order of gate lines in the next group when the driving order of gate lines in one group is completed.

If the determination of the driving order of gate lines in a first group is completed, the determination of the driving order of gate lines in a second group may be started, based on a data corresponding to the last gate line of which driving order is determined in the first group.

As described above, the gate lines are divided into a plurality of groups, and the driving order of gate lines in a corresponding group is determined, so that it is possible to improve the searching speed in the high-resolution, large-sized display device having a large number of gate lines.

In this case, the storage and/or supply of data corresponding to the gate lines in the previous group, of which driving order has been completed, can be performed while the driving order of gate lines in the next group is being determined, thereby decreasing the time required to determine the driving order of the gate lines.

Meanwhile, although an example in which the present invention is applied to the organic light emitting display device using the digital driving method has been described, the present invention is not necessarily limited thereto. That is, it will be apparent that the technical spirit of the present invention may be applied to other display device such as a plasma display panel (PDP). In this case, the technical spirit of the present invention may be applied both address display separation (ADS) and address while display (AWD) methods.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A display device, comprising:
a plurality of pixels positioned at intersection portions of gate lines and data lines;
a gate driver selectively driving the gate lines;
a data driver supplying, to the data lines, data corresponding to the gate line selected from the gate lines; and
a timing controller controlling the gate drive and the data driver, the timing controller including an order determination unit that compares data for each gate line and determines a driving order of the gate lines.

2. The display device of claim 1, wherein the order determination unit performs a test for the degree of similarity between data for each gate line, and determines the driving order of the gate lines so that data having high degrees of similarity are consecutively supplied to the data lines.

3. The display device of claim 1, wherein the data are supplied in the form of digital binary code data, and the order determination unit determines the driving order of the gate lines by comparing data assigned to the same data line for each gate line and counting the number of data agreed with each other.

4. The display device of claim 3, wherein the order determination unit includes an exclusive or operator that counts the number of the data agreed with each other.

5. The display device of claim 1, wherein the order determination unit performs the test for the degree of similarity with respect to data corresponding to the other gate lines, based on a data corresponding to a predetermined first gate line, and selects, as a second gate line, a gate line to which a data most similar to that corresponding to the first gate line is assigned.

6. The display device of claim 5, wherein the order determination unit determines the driving order of all the gate lines by repeating a process of selecting a third gate line by performing the test for the degree of similarity with respect to data corresponding to the other gate lines, based on a data corresponding to the second gate line, after the second gate line is selected, and performing the test for the degree of similarity with respect to data corresponding to the other gate lines, based on a data corresponding to the third gate line.

7. The display device of claim 6, wherein the order determination unit provides a flag bit to the data corresponding to the gate lines of which driving order is determined, so that when the test for the degree of similarity is subsequently performed, based on a data corresponding to another gate line, the test of the degree of similarity with respect to the gate lines having the flag bit provided thereto is excluded.

8. The display device of claim 5, wherein the first gate line is set as a gate line disposed on the first horizontal line.

9. The display device of claim 1, wherein the order determination unit performs the test for the degree of similarity with respect to data corresponding to the other gate lines, based on a predetermined first gate line, and
wherein, if a gate line having the degree of similarity greater than a predetermined reference value is searched, the order determination unit selects the searched gate line as a second gate line.

10. The display device of claim 9, wherein, if the second gate line is selected, the order determination unit stops the test for the degree of similarity, based on the first gate line, and simultaneously performs the test for the degree of similarity with respect to data corresponding to the other gate lines, based on a data corresponding to the second gate line.

11. The display device of claim 10, wherein, if a gate line on which the data having the degree of similarity is no less than the reference value is searched while the test for the degree of similarity is being performed, based on the data corresponding to the second gate line, the order determination unit stops the test for the degree of similarity with respect to the second gate line, and selects the searched gate line as a third gate line, thereby determining the driving order of all the gate line.

12. The display device of claim 11, wherein the order determination unit provides a flag bit to the data corresponding to the gate lines of which driving order is determined, so that when the test for the degree of similarity is subsequently performed, based on a data corresponding to another gate line, the test of the degree of similarity with respect to the gate lines having the flag bit provided thereto is excluded.

13. The display device of claim 1, wherein the gate lines are divided into a plurality of groups, and the order determination unit performs a test for the degree of similarity, which compares data corresponding to gate lines in a corresponding group for each group.

14. The display device of claim 13, wherein, if the determination of the driving order of gate lines in one group is completed, the order determination unit determines a driving order of gate lines in a next group.

15. The display device of claim 14, wherein the order determination unit starts the determination of the driving order of the gate lines in the next group, based on a data corresponding to the gate line finally selected in the group in which the determination of the driving order of the gate lines has been completed.

16. The display device of claim 14, wherein the supply of the data corresponding to the gate line in the group in which the determination of the driving order of the gate lines has been completed is performed while the driving order of the gate lines on the next group is being determined.

17. The display device of claim 13, wherein the order determination unit determines the driving order of the gate lines so that the gate lines in each group are sequentially driven.

18. The display device of claim 1, wherein the order determination unit generates a gate driving control signal corresponding to the determined driving order of the gate lines, and supplies the gate driving control signal to the gate driver.

19. The display device of claim 18, wherein the gate driver is implemented as a decoder that selects a gate line by outputting a selection signal corresponding to the gate driving control signal.

20. The display device of claim 1, wherein the display device is driven using a digital method in which one frame is divided into a plurality of subframes, and the gate lines are driven in a driving order determined by the order determination unit for each subframe.

21. The display device of claim 1, wherein the order determination unit generates a gate driving control signal corresponding to the determined driving order of the gate lines, and simultaneously rearranges the data, corresponding to the driving order.

22. The display device of claim 21, further comprising a storage unit storing the date rearranged by the order determination unit.

23. A driving method of a display device, comprising:
selecting one gate line to be a reference gate line from a plurality of gate lines and setting the selected gate line as a first gate line;
comparing a data assigned to the first gate line with data corresponding to the other gate lines;
selecting a gate line to be driven next to the first gate line, corresponding to the compared result, and setting the selected gate line as a second gate line;
comparing a data assigned to the second gate line with data corresponding to the other gate lines, based on the second gate line; and
selecting a gate line to be driven next to the second gate line, corresponding to the compared result, and setting the selected gate line as a third gate line,
wherein the driving order of all the gate lines is determined while repeating a process of setting a gate line to be driven next to a reference gate line by changing one gate line into a gate line to be the reference gate line whenever the driving order of the one gate line is determined, and comparing a data corresponding to the reference with data corresponding to the other gate lines, and data are supplied to data lines while driving the gate lines, corresponding to the driving order.

24. The driving method of claim 23, wherein the comparing of the data for each gate line includes performing a test for the degree of similarity between the data, and determining the driving order of the gate lines so that data having high degrees of similarity are consecutively supplied to the data lines.

25. The driving method of claim 23, wherein a gate line disposed on the first horizontal line is set as the first gate line.

26. The driving method of claim 23, wherein the comparing of the data assigned to the reference gate line with the data corresponding to the other gate lines includes detecting a comparison result by comparing the data corresponding to the reference gate line with data corresponding to all gate lines of which driving order is not determined yet.

27. The driving method of claim 26, wherein the comparing of the data assigned to the reference gate line with the data corresponding to the other gate lines includes performing a test for the degree of similarity between two data, and selecting a gate line to which a data the highest degree of similarity is assigned among the other gate lines as a gate line to be driven next to the reference gate line.

28. The driving method of claim 23, wherein a flag bit is provided to the data corresponding to the gate lines of which driving order is determined, so that when the test for the degree of similarity is subsequently performed, based on a data corresponding to another gate line, the test of the degree of similarity with respect to the gate lines having the flag bit provided thereto is excluded.

29. The driving method of claim 23, wherein the comparing of the data assigned to the first gate line with the data corresponding to the other gate lines includes performing a test for the degree of similarity between two data, and
wherein, if a data having the degree of similarity greater than a predetermined reference value is searched, the test for the degree of similarity is stopped, based on the first gate line, and a gate line to which the searched data is assigned is set as the second gate line.

30. The driving method of claim 23, wherein the gate lines are divided into a plurality of groups, and the driving order of gate lines in a corresponding group is determined for each group.

31. The driving method of claim 30, wherein the driving order of the gate lines is determined so that the gate lines in each group are sequentially driven.

32. The driving method of claim 31, wherein, if the determination of the driving order of gate lines in one group is completed, the driving order of gate lines in a next group is determined by setting the gate line finally driven in the one group as the first gate line.

33. The driving method of claim 32, wherein data corresponding to the gate lines in the group in which the determination of the driving order of the gate line has been completed are supplied while the driving order of the gate lines in the next group is determined.
